(19) United States
(12) Patent Application Publication
(10) Pub. No.: US 2021/0254975 A1
(43) Pub. Date: Aug. 19, 2021

(54) SURVEY INSTRUMENT INSTALLATION DEVICE

(71) Applicant: Topcon Corporation, Tokyo (JP)

(72) Inventors: Noriyasu KIRYUU, Fujimi-shi (JP); Hideyuki MATSUMOTO, Toda-shi (JP); Nobuyuki NISHITA, Hadano-shi (JP)

(73) Assignee: Topcon Corporation, Tokyo (JP)

(21) Appl. No.: 17/151,112

(22) Filed: Jan. 15, 2021

(30) Foreign Application Priority Data
Feb. 17, 2020 (JP) 2020-24018

(51) Int. Cl. G01C 15/06

(52) U.S. Cl. CPC G01C 15/06

(57) ABSTRACT

Provided is a survey instrument installation device that can be easily installed at a measurement point or a reference point. A survey instrument installation device including at least one leg includes: a pole reception unit provided in the survey instrument installation device; and a pole configured to support a survey instrument, the pole being inserted into the pole reception unit, wherein a lower end of the pole functions as a shoe installed at a reference point, and the pole reception unit supports the pole tiltable in all directions and supports the pole movable in an axial direction.

### CROSS-REFERENCE TO RELATED APPLICATIONS

This application claims priority to Japanese Patent Application Serial No. 2020-24018, filed Feb. 17, 2020, the disclosure of which is incorporated herein by reference in its entirety.

### FIELD

The present invention relates to a survey instrument installation device for installing a survey instrument.

### BACKGROUND

A tripod is common as a survey instrument installation device for installing a survey instrument at a measurement point or a known point.

The survey instrument is attached to an upper end of the tripod, and adjusts a tripod installation position where a mechanical reference point of the survey instrument is located directly above a measurement point or a known point. For example, a laser beam emitted downward from a plumb bob or the survey instrument is used as a method to confirm that the mechanical reference point is located directly above the measurement point or the known point. Additionally, the distance from the ground to the mechanical reference point has been measured by use of a tape rule or the like.

Accordingly, in order to accurately install the survey instrument at the reference point or the measurement point, it is required to repeat tripod installation and measurement, which are cumbersome operation that takes time and requires skill.

### SUMMARY

The present invention provides a survey instrument installation device that can be easily installed at a measurement point or a reference point.

The invention relates to a survey instrument installation device including at least one leg, the survey instrument installation device including: a pole reception unit provided in the survey instrument installation device; and a pole configured to support a survey instrument, the pole being configured to be inserted into the pole reception unit, wherein a lower end of the pole is configured to function as a shoe installed at a reference point R, and the pole reception unit is configured to support the pole tiltable in all directions and support the pole movable in an axial direction.

In addition, the invention relates to a survey instrument installation device, wherein the survey instrument installation device is a tripod, and the pole reception unit is provided on an upper end of the tripod.

In addition, the invention relates to a survey instrument installation device, wherein the survey instrument installation device is a bipod, and the pole reception unit is provided on an upper end of the bipod.

In addition, the invention relates to a survey instrument installation device, wherein the survey instrument installation device is a monopod, and the pole reception unit is provided on an upper end of the monopod.

In addition, the invention relates to a survey instrument installation device, wherein the pole reception unit is provided on one leg of the survey instrument installation device via an adapter.

According to an aspect of the invention, a survey instrument installation device including at least one leg includes: a pole reception unit provided in the survey instrument installation device; and a pole configured to support a survey instrument, the pole being configured to be inserted into the pole reception unit, a lower end of the pole is configured to function as a shoe installed at a reference point R, and the pole reception unit is configured to support the pole tiltable in all directions and support the pole movable in an axial direction. Thus, the survey instrument installation device can be roughly installed at the reference point R and the shoe can be caused to coincide with the reference point R by tilting the pole and moving the pole in the axial direction, thereby achieving the excellent effect of significantly facilitating the installation operation of the survey instrument installation device.

### BRIEF DESCRIPTION OF THE DRAWINGS

FIG. 1 is a schematic diagram illustrating a first embodiment of the invention.

FIG. 2 is an explanatory diagram illustrating the installation state of the first embodiment on an inclined surface.

FIG. 3 is a perspective diagram illustrating a first specific example of a pole reception unit used in the embodiment of the invention.

FIG. 4 is a perspective diagram illustrating the first specific example of the pole reception unit used in the embodiment of the invention.

FIG. 5 is a perspective diagram illustrating a second specific example of the pole reception unit used in the embodiment of the invention.

FIG. 6 is a schematic diagram illustrating a second embodiment.

FIG. 7 is a schematic diagram illustrating a third embodiment.

FIG. 8 is a schematic diagram illustrating a fourth embodiment.

### DESCRIPTION OF EMBODIMENTS

Embodiments of the invention will be described next with reference to the drawings.

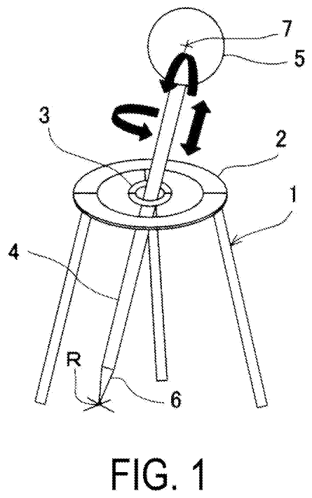

FIG. 1 illustrates an overview of a survey instrument installation device according to a present embodiment.

In FIG. 1, reference numeral 1 denotes a tripod 1 that functions as a survey instrument installation device, and a commercially available tripod may be used as the tripod 1.

The tripod 1 includes a base ring 2 for mounting a survey instrument or other equipment at an upper end, and the center of the base ring 2 coincides with the center of the tripod 1. Typically, the survey instrument is attached to the base ring 2 in a fitting manner. In the drawings, for clarification, the base ring 2 is illustrated large.

In the present embodiment, the survey instrument is not attached to the base ring 2. The base ring 2 is provided with a pole reception unit 3 as described below. Note that a separate adapter may be provided without using the base ring 2, and the pole reception unit 3 may be attached to the adapter.

Note that in the present embodiment, the pole reception unit 3 is attached to the base ring 2. The pole reception unit 3 is engageable with the base ring 2 and further, the pole reception unit 3 may be detachable from the base ring 2.

A pole 4 for supporting the survey instrument is attached via the pole reception unit 3. The pole 4 is attached through the pole reception unit 3. Additionally, the pole 4 may be detachable from the pole reception unit 3.

The pole reception unit 3 supports the pole 4 tiltable (being able to precess) in all directions and supports the pole movable in the axial direction. Additionally, the movement of the pole 4 in the axial direction preferably can be locked. Alternatively, the pole reception unit 3 may hold the pole 4 with a frictional force that does not allow the pole 4 to fall under its own weight.

A survey instrument 5 is attached to an upper end of the pole 4, and a lower end of the pole 4 serves as a shoe 6. The distance between a mechanical reference point 7 of the survey instrument 5 and a tip of the shoe 6 is known, and the mechanical reference point 7 is present on the axis of the pole 4, or when the mechanical reference point 7 deviates from the axis of the pole 4, the amount of eccentricity from the axis is known. Additionally, the survey instrument 5 may be provided on the middle of the pole 4. In this case, the distance between a lower end of the shoe 6 and the survey instrument 5, and the relation between the axis of the pole 4 and a reference point R are known.

Additionally, the survey instrument 5 includes an attitude detection device that can detect an inclination amount and an inclination direction with respect to the horizontal direction. Examples of the survey instrument 5 are disclosed in JP 2017-44550 A and JP 2017-90244 A, and examples of the attitude detection device are disclosed in JP 2017-44550 A and JP 2017-90244 A.

Next, the operation of installing the survey instrument 5 is described.

In FIG. 1, R denotes a measurement point or a reference point.

The tripod 1 is roughly installed on the reference point R in the state where the pole 4 is held by the tripod 1 via the pole reception unit 3 and the shoe 6 is retracted from the lower end of the tripod 1. For example, the tripod may be installed such that the reference point R is in a region surrounded by tips of the tripod.

After the installation of the tripod 1, the locking of the pole 4 by the pole reception unit 3 is released. With the shoe 6 floating from the ground, the pole 4 is tilted about the pole reception unit 3 and is further pushed such that the shoe 6 (i.e., the tip of the shoe 6) matches the reference point R.

The weight of the pole 4 (including the weight of the survey instrument 5) is supported on the ground in the state where the shoe 6 (i.e., the tip of the shoe 6) matches the reference point R. The pole 4 is supported by the pole reception unit 3 and the reference point R. Note that the pole reception unit 3 may or need not lock the pole 4.

The attitude of the survey instrument 5, that is, the inclination angle and the inclination direction with respect to the vertical direction, is detected by the attitude detection device provided in the survey instrument 5. Accordingly, the inclination direction and the inclination angle of the pole 4 with respect to the vertical direction are detected.

Furthermore, since the distance between the tip of the shoe 6 and the mechanical reference point 7 is known, based on the inclination direction and the inclination angle of the pole 4 with respect to the vertical direction; and the distance between the tip of the shoe 6 and the mechanical reference point 7, the planar position (planar coordinates) of the mechanical reference point 7 with respect to the reference point R; and the vertical height of the mechanical reference point 7 with respect to the reference point R can be calculated. Furthermore, the three-dimensional position (three-dimensional coordinates) of the mechanical reference point 7 with respect to the reference point R can be determined as a correction value.

Thus, by correcting a measurement result of the survey instrument 5 with the correction value, the measurement result of the survey instrument 5 can be corrected to a measurement result based on the reference point R.

Note that, when the survey instrument 5 includes a leveling device and has a function of detecting the inclination direction and inclination angle with respect to the horizontal direction in leveling, the inclination direction and the inclination angle that are detected by the leveling device may be used.

In the present embodiment, the tripod 1 can be roughly installed with respect to the reference point R and further, the survey instrument 5 can be easily installed even at positions where the survey instrument could not have been installed so far, such as near a wall, as long as the shoe 6 of the pole 4 reaches the positions.

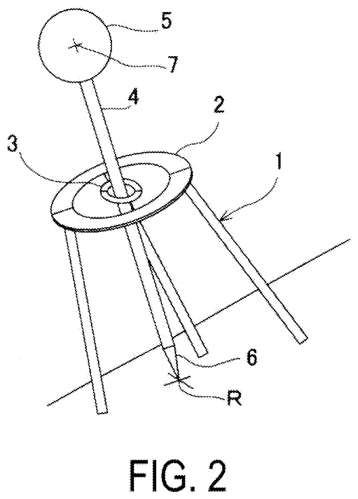

FIG. 2 illustrates a case where the survey instrument 5 is installed on an inclined surface.

The installation operation on the inclined surface is the same as the installation operation described above, and the tripod 1 is roughly installed at the reference point R and the tip of the shoe 6 is caused to coincide with the reference point R to complete the operation of installing the survey instrument 5.

In this case, the pole 4 may be tilted, but the pole 4 can be installed substantially vertically by selecting the position of the tripod 1. Thus, the survey instrument can be easily installed even on the inclined surface that is not covered by the leveling function of the survey instrument.

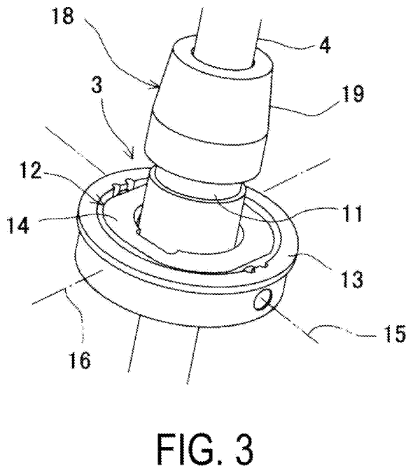

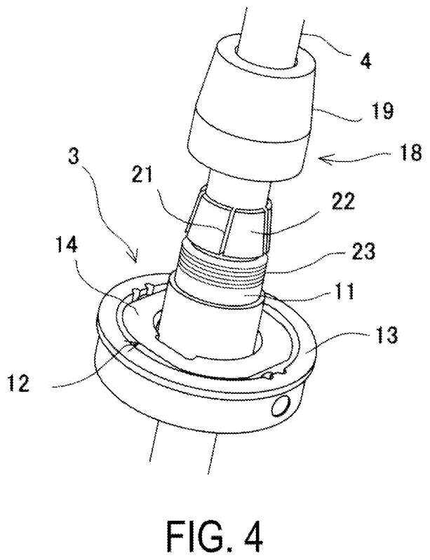

FIGS. 3 and 4 illustrate a first specific example of the pole reception unit 3.

In the first specific example, the pole reception unit includes: a pole support pipe 11 into which the pole 4 is inserted, a gimbal mechanism 12 that supports the pole support pipe 11, and an outer ring 13 that supports the gimbal mechanism 12 and is engageable with the base ring 2.

Further, the gimbal mechanism 12 is configured such that an inner ring 14 is rotatably supported by the outer ring 13 via a first axis 15, and the pole support pipe 11 is rotatably supported by the inner ring 14 via a second axis 16 that is orthogonal to the first axis 15. In this manner, the pole 4 is supported by the tripod 1 via the pole reception unit 3 tiltable in all directions.

Further, a pole holding portion 18 is provided on an upper end of the pole support pipe 11.

The pole holding portion 18 includes a nut 19 that fits over an upper end portion of the pole support pipe 11. Additionally, the upper end portion of the pole support pipe 11 is tapered, and the upper end portion is divided into a required number of tongues 22 by slits 21. Additionally, a screw 23 is engraved below the tongues 22. The nut 19 is engaged with the tongues 22 and is threadedly engaged with the screw 23.

Thus, when the nut 19 is threadedly engaged with the upper end portion of the pole support pipe 11 and tightened, the tongues 22 decrease in diameter, and the pole holding portion 18 causes the pole reception unit 3 to hold the pole 4.

Furthermore, when the screw 23 is tightly tightened, the pole 4 is locked by the pole reception unit 3, and when the screw is lightly tightened, an external force enables taking in and out of the pole 4 to adjust the position of the shoe 6, while preventing the pole 4 from falling due to its own weight with a frictional force between the pole 4 and the tongues 22.

The pole 4 can be adjusted to a freely selected position and locked at the freely selected position by adjusting the tightening force of the nut 19.

Note that when locking of the pole 4 is not necessary, a high friction member such as an O-ring may be provided in place of the tongues 22 to provide some frictional force between the pole support pipe 11 and the pole 4, preventing the pole 4 from falling due to its own weight.

Alternatively, the pole 4 can be locked in various ways, for example, by providing a lock lever and pressing a friction member onto the pole 4 with the rotation of the lock lever, or by tightening a band to decrease the pole support pipe 11 in diameter. The pole 4 may be further locked using a set screw.

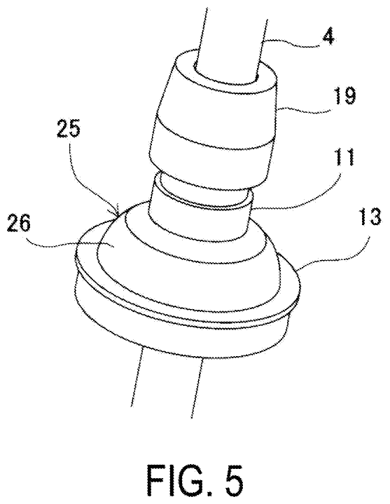

FIG. 5 illustrates a second specific example of the pole reception unit 3.

In the second specific example, a spherical bearing 25 is used as a method to support the pole 4 tiltable in all directions.

The pole 4 can be tilted in all directions with respect to the tripod 1 by being supported by the outer ring 13 via a spherical body 26. Additionally, the pole 4 can be held at a freely selectable angle by interposing a friction member between the spherical body 26 and the outer ring 13, or by selecting materials of the outer ring 13 and the spherical body 26 that can generate a frictional force therebetween.

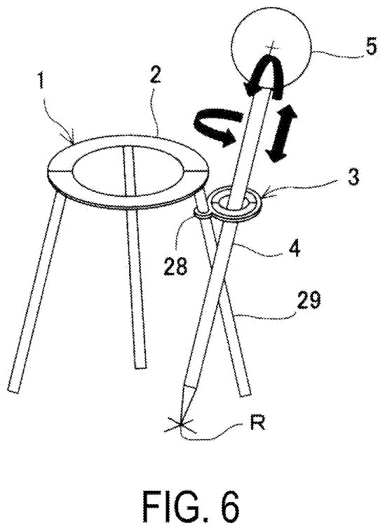

FIG. 6 illustrates a second embodiment.

In the second embodiment, it is illustrated that the pole reception unit 3 is attached to one of legs 29 of the tripod 1 via an adapter 28.

In this case, the pole 4 is supported outside the tripod 1, but there is no obstacle to the installation of the pole 4 (the survey instrument 5) at the reference point R. The second embodiment is advantageous when specifications of the base ring 2 and the pole reception unit 3 are not compatible, or any other device such as a camera, video camera, or the like has been mounted on the tripod 1.

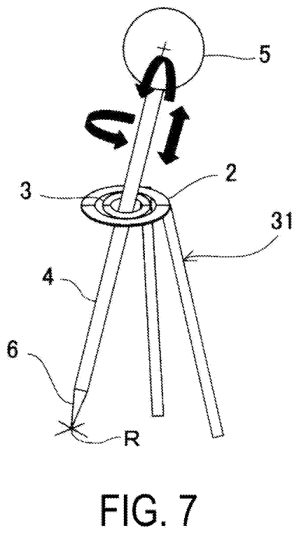

FIG. 7 illustrates a third embodiment. In the third embodiment, a bipod 31 is used as the survey instrument installation device.

Also in the third embodiment, similarly to the embodiments described above, the bipod 31 is roughly installed in the vicinity of the reference point R and supports the pole 4 via the pole reception unit 3, and then the pole 4 is tilted to be installed at the reference point.

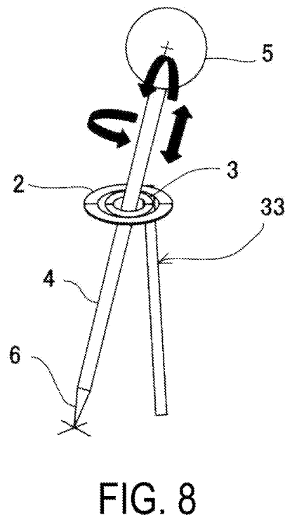

FIG. 8 illustrates a fourth embodiment. In the fourth embodiment, a monopod 33 is used as the survey instrument installation device.

Also in the fourth embodiment, the monopod 33 is roughly installed in the vicinity of the reference point R and supports the pole 4 via the pole reception unit 3, and then the pole 4 is installed at the reference point.

In the fourth embodiment, the monopod 33 can support the weights of the pole 4 and the survey instrument 5, the pole 4 can be tilted using the monopod 33 as a fulcrum, and the pole 4 is installed at the reference point R, which makes the operation simple.

Needless to say, in both the third and fourth embodiments, the pole reception unit 3 may be attached to the middle of the leg via the adapter.

### REFERENCE SIGNS LIST

1 Tripod
2 Base ring
3 Pole reception unit
4 Pole
5 Survey instrument
7 Mechanical reference point
11 Pole support pipe
12 Gimbal mechanism
25 Spherical bearing
28 Adapter
31 Bipod
33 Monopod

What is claimed is:

1. A survey instrument installation device including at least one leg, the survey instrument installation device comprising:
a pole reception unit provided in the survey instrument installation device; and
a pole configured to support a survey instrument, the pole being configured to be inserted into the pole reception unit,
wherein a lower end of the pole is configured to function as a shoe installed at a reference point R, and
the pole reception unit is configured to support the pole tiltable in all directions and support the pole movable in an axial direction.

2. The survey instrument installation device according to claim 1,
wherein the survey instrument installation device is a tripod, and the pole reception unit is provided on an upper end of the tripod.

3. The survey instrument installation device according to claim 1,
wherein the survey instrument installation device is a bipod, and the pole reception unit is provided on an upper end of the bipod.

4. The survey instrument installation device according to claim 1,
wherein the survey instrument installation device is a monopod, and the pole reception unit is provided on an upper end of the monopod.

5. The survey instrument installation device according to claim 1,
wherein the pole reception unit is provided on one leg of the survey instrument installation device via an adapter.
